(19) United States
(12) Patent Application Publication
(10) Pub. No.: US 2021/0200132 A1
(43) Pub. Date: Jul. 1, 2021

(54) IMAGE FORMING APPARATUS

(71) Applicant: CANON KABUSHIKI KAISHA, Tokyo (JP)

(72) Inventors: Masahito Kato, Shizuoka (JP); Yoshihiro Mitsui, Shizuoka (JP); Yuichiro Hirata, Shizuoka (JP)

(21) Appl. No.: 17/131,829

(22) Filed: Dec. 23, 2020

(30) Foreign Application Priority Data
Dec. 27, 2019 (JP) 2019-238269

(51) Int. Cl. G03G 15/00

(52) U.S. Cl. CPC G03G 15/5033; G03G 15/55

(57) ABSTRACT

In an image forming apparatus, when a cartridge is unused, a control portion performs a preparatory operation of initiating rotational drive of a rotating member in a first rotational speed by second drive unit, and then initiating rotational drive of an image bearing member by first drive unit with the surface of the rotating member in contact with the surface of an image bearing member and then, driving the rotating member in a second rotational speed smaller than the first rotational speed prior to the image forming operation, and a ratio of the surface movement speed of the first rotational speed of the rotating member to the surface movement speed of the image bearing member in the preparatory operation is greater than the ratio of the surface movement speed of the rotating member to the surface movement speed of the image bearing member in the image forming operation.

### BACKGROUND OF THE INVENTION

### Field of the Invention

The present invention relates to an image forming apparatus such as a copier, laser beam printer or fax machine that uses an electrophotographic system or electrostatic recording system.

### Description of the Related Art

To facilitate developer replenishment and maintenance of various process unit in a conventional image forming apparatus, configurations are known in which the process unit are integrated as a cartridge and made detachable from the main body of the image forming apparatus. Process unit include the photosensitive body (photosensitive drum), charging member, developing unit, cleaning member and the like, which are often assembled in a housing and called a process cartridge. An image forming apparatus with excellent usability can be provided with a process cartridge system.

Device configurations are also known that have a cleaning blade disposed in contact with the photosensitive drum in the opposite direction from the direction of rotation for the purpose of removing residual toner from the photosensitive drum surface. The cleaning blade has elasticity and cleans the surface of the rotating photosensitive drum by contacting the surface (peripheral surface) of the photosensitive drum in a specific area to form a nip between the cleaning blade and the photosensitive drum.

In recent years, however, smaller and less expensive motors are being required in order to reduce the size of the image forming apparatus, and reductions the drive torque of the photosensitive drum are particularly desired.

For example, Japanese Patent Application Publication No. H06-118856 discloses a technique whereby the friction force between the photosensitive drum and the cleaning blade is reduced by coating the cleaning blade with a lubricant.

Japanese Patent Application Publication No. 2010-038973 discloses an apparatus configured with a photosensitive drum containing a lubricant material in the surface layer, and so that a developer application sequence is performed during the initial rotation operation. With this configuration, the frictional force between the photosensitive drum and the cleaning blade is reduced, and the frictional force reduction effect can be sustained because the developer application sequence is performed during the initial rotation operation.

### SUMMARY OF THE INVENTION

Even with the configurations disclosed in Japanese Patent Application Publication No. H06-118856 and Japanese Patent Application Publication No. 2010-038973 above, there is a need for further motor size reductions and cost reductions, and in particular for reductions in the drive load when a new process cartridge is driven for the first time.

It is an object of the present invention to provide an image forming apparatus capable of providing further reductions in the drive load.

To achieve this object, the image forming apparatus of the invention is provided with the following:

a cartridge provided with a rotatable image bear member;

a rotating member rotatable in contact with the surface of the image bearing member;

first drive unit for rotationally driving the image bearing member;

second drive unit for rotationally driving the rotating member;

detection unit for detecting the usage state of the cartridge; and

a control portion,

wherein prior to the image forming operation of forming an image, when the detection unit detects that the cartridge is an unused cartridge,

the control portion performs a preparatory operation of initiating rotational drive of the rotating member by the second drive unit, and then initiating rotational drive of the image bearing member in a first rotational speed by the first drive unit with the surface of the rotating member in contact with the surface of the image bearing member, and then, driving the rotating member in a second rotational speed smaller than the first rotational speed and

wherein a ratio of the surface movement speed of the first rotational speed of the rotating member to the surface movement speed of the image bearing member in the preparatory operation is greater than the ratio of the surface movement speed of the rotating member to the surface movement speed of the image bearing member in the image forming operation.

The present invention can provide an image forming apparatus with reduced drive load.

Further features of the present invention will become apparent from the following description of exemplary embodiments with reference to the attached drawings.

### BRIEF DESCRIPTION OF THE DRAWINGS

FIG. 1 shows the initial preparatory operation control sequence in Example 1,

FIG. 2 is a schematic cross-section showing the image forming apparatus of Example 1,

FIG. 3 is a schematic cross-section of a process cartridge in Example 1,

FIG. 4 is a model view 1 of protrusions on a toner particle in Example 1,

FIG. 5 is a model view 2 of a protrusion on a toner particle in Example 1,

FIG. 6 is a model view 3 of a protrusion on a toner particle in Example 1,

FIG. 7 is a model view 4 of a protrusion on a toner particle in Example 1,

FIG. 8 shows the toner supply operation sequence in Example 1,

FIGS. 9A and 9B are schematic views showing a comparison between the drive torques in Example 1 and a comparative example,

FIG. 10 is an expanded view of the contacting portions of the photosensitive drum and the cleaning member in Example 1,

FIG. 11 shows the initial preparatory operating control sequence in Example 2,

FIG. 12 shows the toner supply operation sequence in Example 2,

FIG. 13 is a control block diagram of an example, and

FIGS. 14A and 14B are schematic views illustrating a contact-separation mechanism of an example.

### DESCRIPTION OF THE EMBODIMENTS

Embodiments of the present invention are explained in detail based on examples with reference to the drawings below. Unless otherwise specified, however, the dimensions, materials and forms of the constituent parts described in these embodiments and their relative placement and the like are not intended to limit the scope of the invention. Furthermore, once the functions, materials and forms of members have been explained below, they are subsequently the same as in the first explanation unless otherwise stated.

### Example 1

In the explanations of Example 1 below, the overall configuration of the image forming apparatus and the configuration of the process cartridge are explained as matters that are common to Example 1 and Example 2, while the details of the initial preparatory operation are explained as a matter that is characteristic of Example 1.

Overall Configuration of Image Forming Apparatus

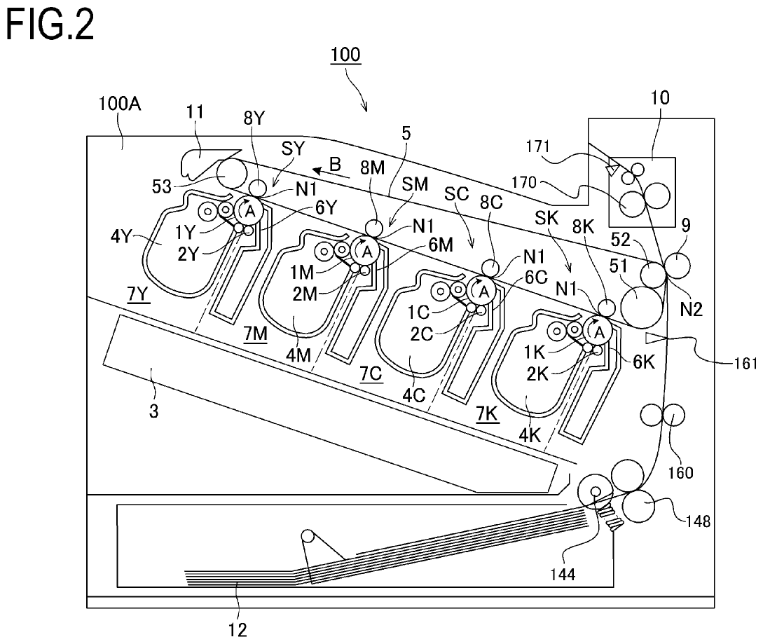

The overall configuration of the electrophotographic image forming apparatus of Example 1 of the invention (image forming apparatus) is explained first. FIG. 2 is a schematic cross-section showing the image forming apparatus of Example 1. The image forming apparatus 100 of this example is a full color laser printer using in-line type and an intermediate transfer system. The image forming apparatus 100 forms full color images on a recording material (such as a recording paper, plastic sheet, cloth or the like) in response to image data. The image data is input into the main body 100A of the image forming apparatus 100 from an image reading unit connected to the main body 100A or from a host device such as a personal computer connected communicatively with the main body 100A.

As multiple image forming portions, the image forming apparatus 100 has 1st, 2nd, 3rd and 4th image forming portion SY, SM, SC and SK for forming yellow (Y), magenta (M), cyan (C) and black (K) colored images, respectively. In this example, the 1st through 4th image forming portions SY, SM, SC and SK are disposed in a row intersecting the vertical direction.

In this example, the configurations and operations of the 1st through 4th image forming portions SY, SM, SC and SK are all effectively the same apart from the colors of the images to be formed. Thus, unless distinctions are particularly necessary, the notations Y, M, C and K indicting that an element is provided for a particular color are omitted in favor of general explanations.

In this example, the image forming apparatus 100 has four drum-shaped electrophotographic photosensitive bodies or in other words multiple photosensitive drums 1 as image bearing members aligned in a row a direction intersecting the vertical direction. Each photosensitive drum 1 is driven rotationally by drive unit (drive source, not shown) in the direction of the arrow A in the figure (clockwise direction). A charging roller 2 as charging member for uniformly charging the surface of the photosensitive drum 1 and a scanner unit (exposure unit) 3 as light exposure unit for forming electrostatic images (electrostatic latent images) on the photosensitive drum 1 by exposing it to laser light based on image data are disposed around the photosensitive drum 1. A developing unit (developing device) 4 as developing portion for developing the electrostatic images into toner images and a cleaning member 6 as cleaning portion for removing residual toner (untransferred toner) from the surface of the photosensitive drum 1 after transfer are also disposed around the photosensitive drum 1. An intermediate transfer belt 5 is also disposed facing the 4 photosensitive drums 1 as an intermediate transfer body for transferring the toner images on the photosensitive drums 1 to a recording material 12.

In this example, the developing unit 4 uses a non-magnetic one-component developer as a developer. Moreover, in this example the developing unit 4 performs reverse development through contact between the photosensitive drum 1 and the developing roller (described below) as a developer carrying member. That is, in this example the developing unit 4 develops electrostatic latent images by causing toner that has been charged to the same polarity as the charging polarity of the photosensitive drum 1 (negative polarity in this case) to adhere to the portion of the photosensitive drum 1 (image portion, exposed portion) where the charge has been attenuated by light exposure.

In this example, the photosensitive drum 1, the charging roller 2 as process unit acting on the photosensitive drum 1, and the developing unit 4 and cleaning member 6 are integrated in other words united in a single cartridge, forming a process cartridge 7. Each process cartridge 7 can be attached and detached from the image forming apparatus 100 via mounting member such as a mounting guide or positioning member provided on the main body 100A of the apparatus. In this example the differently colored process cartridges 7 all have the same shape, and the respective yellow (Y), magenta (M), cyan (C) and black (K) colored toners are contained in the corresponding process cartridges 7 for each color.

Intermediate transfer belt 5, which is formed as a continuous belt as an intermediate transfer member, contacts all of the photosensitive drums 1 as a rotating member capable of rotating in contact with the surfaces of the image bearing members, and moves circularly (rotates) in the B direction shown by the arrow (counter-clockwise direction). The intermediate transfer belt 5 is supported by a drive roller 51, secondary transfer facing roller 52 and passive roller 53 as multiple supporting members.

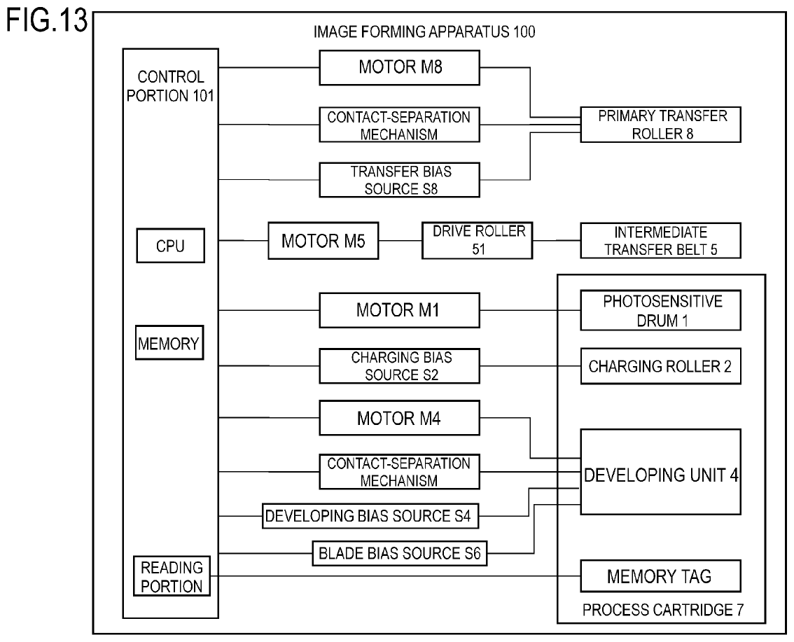

Four primary transfer rollers 8 are provided in a row as primary transfer member (transfer members) on the inner peripheral surface of the intermediate transfer belt 5 facing the corresponding photosensitive drums 1. The primary transfer rollers 8 press the intermediate transfer belt 5 towards the photosensitive drums 1, forming primary transfer portions N1 through contact between the intermediate transfer belt 5 and the photosensitive drums 1. Bias with the opposite polarity to the normal charging polarity of the toner is then applied to the primary transfer rollers 8 from a primary transfer bias power source (high voltage power supply) S8 (see FIG. 13) as primary transfer bias application unit. The toner image (developer image) on the photosensitive drums 1 is thus transferred to the intermediate transfer belt 5 (primary transfer).

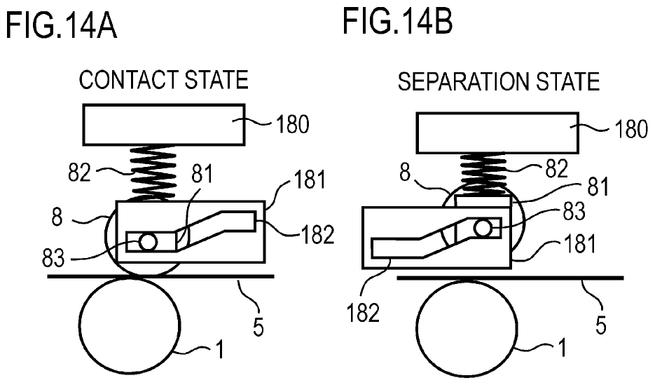

FIGS. 14A and 14B are schematic views illustrating the configuration of a contact-separation mechanism whereby contact and separation states between the primary transfer roller 8, the intermediate transfer belt and 5 and the photosensitive drum 1 are formed by displacement of the primary transfer roller 8. FIG. 14A illustrates a contact state, while FIG. 14B illustrates a separation state. As shown in FIGS. 14A and 14B, in this example a pressure spring 82 is provided between the main body frame 180 and bearings 81 provided at either end of each primary transfer roller 8, and the force applied by the pressure spring 82 pushes the primary transfer roller 8 towards the intermediate transfer belt 5. Each bearing 81 is provided with a contact-separation boss 83 that creates the contact and separation states. This contact-separation boss 83 fits into a guide groove 182 provided in a contact-separation slider 181, which is configured so that it can slide in a direction roughly parallel to the direction of belt movement in response to force applied by a drive source (not shown). The sliding movement of the contact-separation slider 181 changes the position where the guide groove 182 regulates the contact-separation boss 83 (deflects the bearing 81 against the force of the pressure spring 82), thereby switching the relative positions of the primary transfer roller 8 and the intermediate transfer belt 5 from a contact state to a separation state.

The configuration of the contact-separation mechanism here is only one example, and the mechanism is not limited to this configuration. Furthermore, although the contact and separation states in this case are created by displacing the primary transfer roller 8, for example contact and separation states can also be created by displacing the photosensitive drum 1 or by displacing both the primary transfer roller 8 and the photosensitive drum 1.

Looking at the surface speed (surface movement speed) of the intermediate transfer belt during image formation, the belt rotates at a peripheral speed ratio of 101.5% relative to the surface speed of the photosensitive drum.

A secondary transfer roller 9 is provided as secondary transfer member in a position facing the secondary transfer facing roller 52 on the outer peripheral surface of the intermediate transfer belt 5. The secondary transfer roller 9 exerts contact pressure on the secondary transfer facing roller 52 on the other side of the intermediate transfer belt 5, and a secondary transfer portion N2 is thus formed by contact between the intermediate transfer belt 5 and the secondary transfer roller 9. Bias with the opposite polarity to the normal charging polarity of the toner is applied to the secondary transfer roller 9 from a secondary transfer bias power source (high voltage power supply, not shown) as secondary transfer bias application unit. The toner image on the intermediate transfer belt 5 is thus transferred to the recording material 12 (secondary transfer).

The image forming apparatus 100 of this example is provided with a pick-up roller 144, conveying rollers 148 and paper stop rollers 160 as conveying member for conveying the recording material 12 to the secondary transfer portion. The recording material 12 is supplied by the pick-up roller 144 with a predetermined timing from the start of exposure. It is then conveyed by the conveying rollers 148 to the paper stop rollers 160, and then further conveyed by the paper stop rollers 160 to the secondary transfer portion N2 where the secondary transfer roller 9 is located. Once the paper detection sensor 161 senses the leading end of the recording material 12, the conveying rollers 148 and paper stop rollers 160 are paused, putting the system on standby. The operations of the conveying rollers 148 and paper stop rollers 160 are then restarted with a pre-determined timing. The recording material 12 in a standby state then starts to move and is conveyed to the secondary transfer portion N2. Feed and re-feed of the recording material 12 are thus performed with a predetermined timing from the start of exposure, and the toner image on the intermediate transfer belt 5 is precisely overlaid on the recording material 12 in the secondary transfer portion N2. As a result, the toner image is secondarily transferred onto the recording material 12 without misalignment.

The series of image forming operations is explained here. First, the surface of the photosensitive drum 1 is charged uniformly by the charging roller 2. Next, the surface of the charged photosensitive drum 1 is subjected to scanning exposure by laser light in accordance with image data from the scanner unit 3, forming an electrostatic image corresponding to the image data on the photosensitive drum 1. Next, the electrostatic latent image formed on the photosensitive drum 1 is developed as a toner image by the developing unit 4. The toner image formed on the photosensitive drum 1 is transferred by the operation of the primary transfer roller 8 to the intermediate transfer belt 5 (primary transfer).

When forming full-color images for example, the above process is performed sequentially in each of the 1st through 4th image-forming portions SY, SM, SC and SK, and the toner images of each color are overlaid sequentially on the intermediate transfer belt 5 to perform primary transfer.

The recording material 12 is then conveyed to the secondary transfer portion N2 in synchronicity with the movement of the intermediate transfer belt 5. The 4-color toner image on the intermediate transfer belt 5 is secondarily transferred all at once to the recording material 12 by the action of secondary transfer roller 9, which contacts the intermediate transfer belt 5 with the recording material 12 between the two.

The recording material 12 with the transferred toner image is conveyed to the fixing apparatus 10 as fixing unit. Heat and pressure are applied to the recording material 12 in the fixing apparatus 10 to thereby fix the toner image on the recording material 12.

Residual toner remaining from primary transfer on the photosensitive drum 1 after the primary transfer step is removed by the cleaning member (cleaning blade) 6 and collected. Residual toner remaining from secondary transfer on the intermediate transfer belt 5 after the secondary transfer step is cleaned by the intermediate transfer belt cleaning apparatus 11.

The image forming apparatus 100 can also form single-color images using one desired image forming portion or can be made to form multicolor images using only certain (not all) image-forming portions.

Configuration of Process Cartridge

The overall configuration of the process cartridge 7 mounted on the image forming apparatus 100 in this example is explained next. In this example, the configurations and operations of the process cartridges 7 for each color are effectively the same apart for the type (color) of toner contained in the cartridge.

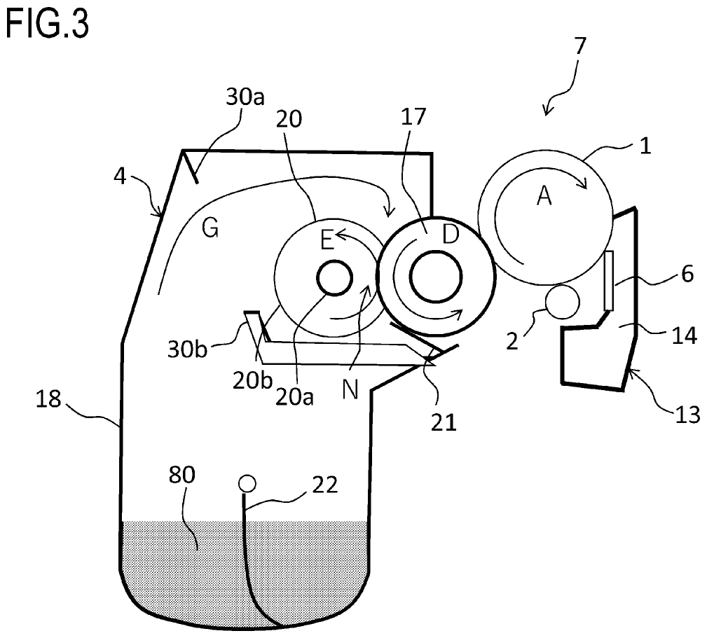

FIG. 3 is a schematic cross-section of the process cartridge of Example 1. The process cartridge 7 in FIG. 3 is oriented as it would appear if mounted on the main body of the image forming apparatus, and descriptions of the positional relationships, directions and the like of the individual members of the process cartridge below refer to the positional relationships, directions and the like in this orientation.

In the process cartridge 7, a photosensitive unit 13 comprising a photosensitive drum 1 and the like and a developing unit 4 comprising a developing roller 17 and the like are configured as a single unit. The photosensitive unit 13 and the developing unit 4 are configured so that the photosensitive drum 1 and the developing roller 17 can assume a contact state and separation state by means of a conventional known contact-separation mechanism.

The photosensitive unit 13 has a cleaning frame 14 as a framework for supporting the various elements within the photosensitive unit 13. The photosensitive drum 1 is rotatably mounted on the cleaning frame 14 via bearings (not shown). When the drive force of a drive motor M1 (FIG. 13) as drive unit (drive source) is transmitted to the photosensitive unit 13, the photosensitive drum 1 is driven rotationally in the direction of arrow A in the figure (clockwise) in conjunction with the image forming operation. In this example, the photosensitive drum 1, which is the center of the image forming process, is an organic photosensitive drum 1 comprising an undercoat layer (functional film), a carrier generating layer, and a carrier convey layer coated in that order on the outer surface an aluminum cylinder.

In the photosensitive unit 13, the cleaning member 6 and charging roller 2 are disposed in contact with the peripheral surface of the photosensitive drum 1. The untransferred toner removed from the surface of the photosensitive drum 1 by the cleaning member 6 falls and is stored in the cleaning frame 14 (hereunder called the waste toner box). The charging roller 2 (charging member) is made to rotate passively when the conductive rubber roller portion is brought into pressurized contact with the photosensitive drum 1.

In the core of the charging roller 2, a predetermined DC voltage is applied to the photosensitive drum 1 from the charging bias source S2 (see FIG. 13) as a charging step, thereby forming a uniform dark potential (Vd) on the surface of the photosensitive drum 1. The photosensitive drum 1 is exposed to a spot pattern of laser light emitted by the aforementioned scanner unit 3 in response to image data, and the exposed area loses its surface charge due to carriers from the carrier generating layer, reducing the potential. As a result, an electrostatic latent image is formed on the photosensitive drum 1 from the specific light potential (Vl) of the exposed area and the specific dark potential (Vd) of the unexposed area. In this example, Vd=−500 V and Vl=−100 V.

Meanwhile, the developing unit 4 has a developing chamber containing a developing roller 17 as a developer carrying member for carrying the toner 80 and a toner supply roller 20 as a supply member for supplying toner to the developing roller 17. The developing unit 4 is also provided with a toner chamber 18 in which a toner container (developer container) for containing toner is located below the toner supply roller 20 in the direction of gravity. It also has an upper wall 30a and a lower wall 30b separating the toner chamber from the developing chamber.

The toner supply roller 20 forms a toner nip portion N with the developing roller 17 (part where toner is sandwiched between the developing roller 17 and the toner supply roller 20) and is rotated by rotational drive force supplied by a motor M4.

The toner chamber 18 contains a stirring and conveying member 22. The stirring and conveying member 22 stirs the toner contained in the toner chamber 18 and also conveys the toner in the direction of the arrow G in the figure towards the top of the toner supply roller 20.

A developing blade 21 disposed below the developing roller 17 contacts the surface of the developing roller 17 in a direction counter to the rotating direction of the developing roller 17 and contributes charge while regulating the coated amount of the toner supplied by the toner supply roller 20. In this example, a 0.1 mm-thick leaf spring shaped SUS thin plate is used as the developing blade 21, and the spring elasticity of the thin plate is used to form contact pressure, bringing the surface of the spring into contact with the toner and the developing roller 17. Although a SUS thin plate is used as the developing blade 21 in this example, this is not a limitation, and a metal thin plate of phosphor bronze or aluminum or the like may also be used. A developing blade 21 that has been surface coated with a thin film of a polyamide elastomer, urethane gum or urethane resin or the like may also be used.

As discussed above, the thickness of the toner layer is regulated while at the same time it acquires a charge through triboelectric charging by rubbing between the developing blade 21 and the developing roller 17. In this example, moreover, a predetermined voltage is applied to the developing blade 21 by a blade bias source S6 (see FIG. 13) to stabilize the toner coat. In this example, a blade bias of V=−500 V was applied.

The developing roller 17 and photosensitive drum 1 each rotate in such a way that the surfaces of each move in the same direction at the facing portions (in this example, direction moving from bottom to top).

In this example, the developing roller 17 is disposed in contact with the photosensitive drum 1, but the developing roller 17 may also be disposed near the photosensitive drum 1 with a specific gap between the two.

In this example, toner that has been negatively charged by triboelectric charging relative to the predetermined DC bias applied to the developing roller 17 is transferred and appears as an electrostatic latent image only on the light potential portions due to the potential difference in the developing unit where it contacts the photosensitive drum 1. In this example, a bias of V=−300 V is applied to the developing roller 17 by a developing bias source S4 (see FIG. 13), forming a potential difference ΔV=200 V with the light potential portions to thereby create a toner image.

The toner supply roller 20 is an elastic sponge roller comprising a foam layer 20b formed on the outer circumference of a conductive core 20a. The toner supply roller 20 and developing roller 17 contact each other with a predetermined amount of intrusion. The toner supply roller 20 and developing roller 17 rotate in opposite directions with a peripheral speed difference in the nip portion N, and this operation causes toner to be supplied to the developing roller 17 by the toner supply roller 20.

Toner

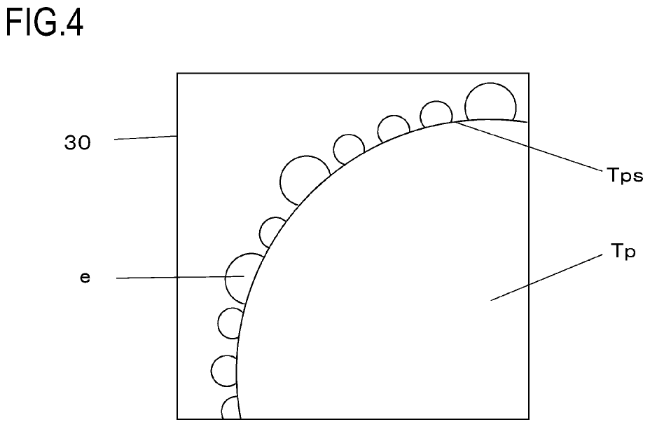

The toner used in this example is explained next. The toner of the invention has protrusions containing an organosilicon polymer on the toner particle surface. These protrusions are in surface contact with the surface of the toner base particle. This surface contact can be expected to have a dramatic suppression effect on movement, detachment and burial of the protrusions. The toner was observed in cross-section by STEM to show the degree of surface contact. FIGS. 4 to 7 are schematic views of the protrusions on the toner particle.

In FIG. 4, the part indicated by the symbol 30 is called a STEM image and illustrates about ¼ of the cross-sectional configuration of a toner particle. In this STEM image, Tp is the toner base particle, Tps is the toner base particle surface, and e is a protrusion. This STEM image shows the cross-sectional configuration of one of four quadrants of a coordinate system originating at the center of the toner particle cross-section, and the remaining 3 quadrants are assumed to have symmetrically similar configurations. A cross-sectional image of the toner is observed, and a line is drawn tracing the periphery of the surface of the toner base particle. The image is then converted to a horizontal image based on this line tracing the periphery. In the horizontal image, the length of a line tracing the periphery at the part where the protrusion and the toner base particle form a continuous boundary is called the protrusion width w. The maximum length of the protrusion in the normal direction of the protrusion width w is called the protrusion diameter d, and the length from the peak of the protrusion at the line segment forming the protrusion diameter d to the line tracing the circumference is called the protrusion height h.

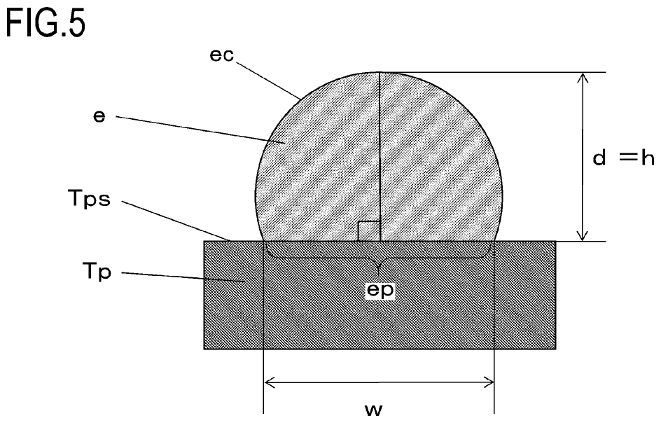

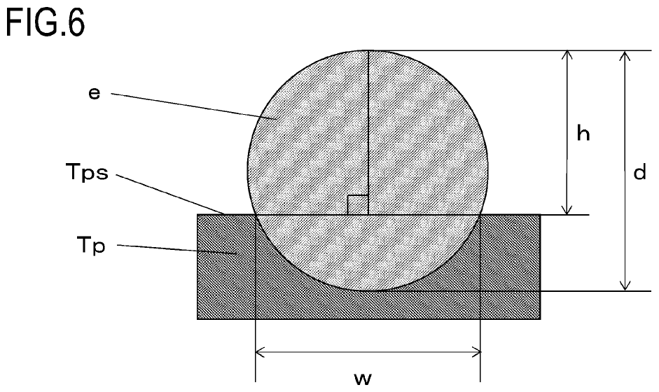

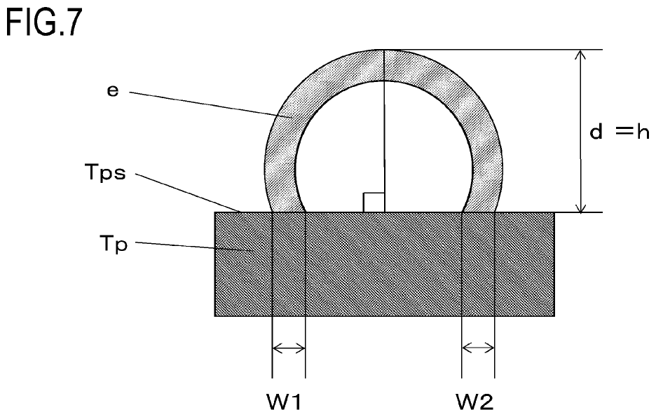

Cross-sectional observation has shown that the protrusions e of the three configurations shown in FIGS. 5 to 7 are typical. The protrusion e shown in the FIG. 5 represents more than half of the protrusion configurations formed in toners manufactured by the manufacturing methods of the examples given below, and this protrusion e has a flat portion ep and a curved portion ec as explained below. In FIGS. 5 and 7, the protrusion diameter d and protrusion height h are the same. In FIG. 6, the protrusion diameter d is greater than the protrusion height h.

Moreover, FIG. 7 illustrates the fixed state of a particle similar to a bowl-shaped particle (a hemispherical particle with an indented center) obtained by crushing or splitting a hollow particle. In FIG. 7, the protrusion width w is the total length of the organosilicon compound that contacts the surface of the toner base particle. That is, the protrusion width w in FIG. 7 is the total of W1 and W2.

Based on the conditions above, it was found that with protrusions of an organosilicon compound, movement, detachment and burial of the protrusions are unlikely with a convex shape in which the ratio d/w of the protrusion diameter d to the protrusion width is from 0.33 to 0.80. That is, it was found that in the case of protrusions with a protrusion height h of from 40 nm to 300 nm, excellent transferability capable of withstanding long-term use is obtained if the number ratio P(d/w) of protrusions with a ratio d/w of from 0.33 to 0.80 is at least 70 number %.

It is thought that with protrusions at least 40 nm in height, transferability is improved because the protrusions have a spacer effect between the transfer member and the toner base particle surface. With protrusions of not more than 300 nm, on the other hand, it is thought that the effect of suppressing movement, detachment and burial throughout an endurance evaluation is dramatically expressed.

It has been found that if the ratio of protrusions of 40 nm to 300 nm is a number ratio P(d/w) of at least 70 number %, an even greater member contamination suppression effect can be achieved while maintaining transferability throughout long-term use. The ratio P(d/w) is more preferably at least 75 number %, or still more preferably at least 80 number %. There is no particular upper limit, but preferably it is not more than 99 number % or still more preferably not more than 98 number %.

In cross-sectional observation of the toner by scanning transmission electron microscopy (STEM), given peripheral length L as the width of the horizontal image (length of line tracing toner base particle surface) and Σw as the total of the protrusion widths w of protrusions with a protrusion height h of 40 nm to 300 nm out of the organosilicon polymer protrusions in the horizontal image, Σw/L is preferably from 0.30 to 0.90.

If Σw/L is at least 0.30, the effects of improving transferability and suppressing member contamination are good, while transferability is better if Σ/L is not more than 0.90. Σw/L is more preferably from 0.45 to 0.80.

The adhesion rate of the organosilicon polymer in the toner is preferably at least 80 mass %. If the adhesion rate is at least 80 mass %, the effects of improving transferability and suppressing member contamination are easy to maintain throughout long-term use. The adhesion rate is preferably at least 90 mass %, or still more preferably at least 95 mass %. There is no particular upper limit, but preferably it is not more than 99 mass %, or more preferably not more than 98 mass %. Methods of controlling the adhesion rate include for example methods of controlling the addition rate of the organosilicon polymer, the reaction temperature, the reaction time, the pH of the reaction and the pH adjustment timing when adding and polymerizing the organosilicon polymer.

To further improve transferability with protrusions having a protrusion height h of from 40 nm to 300 nm, taking the cumulative distribution of the protrusion heights h with h80 being the protrusion height at a cumulative 80 number % from the smallest protrusion height h, h80 is preferably at least 65 nm, or more preferably at least 75 nm. There is no particular upper limit, but preferably it is not more than 120 nm, or more preferably not more than 100 nm.

In observation of the toner by scanning transmission electron microscopy (SEM), given protrusion radius R as the maximum radius of the protrusions of the organosilicon polymer, the number average of the protrusion radius R is preferably from 20 nm to 80 nm, or more preferably from 35 nm to 60 nm. Within this range, contamination of the members is unlikely.

The toner contains an organosilicon polymer having a structure represented by formula (1) below:

[C3]

R—SiO_{3/2} (1)

(in the formula, R represents a C₁₋₆ alkyl group or phenyl group).

In an organosilicon polymer having the structure of formula (1), one of the four valence electrons of the Si atom binds to R, while the other three bind to O atoms. Both of the two valence electrons of each O atom bind to Si, or in other words form a siloxane bond (Si—O—Si). Considering the Si atoms and O atoms in an organosilicon polymer, this is expressed as —SiO_{3/2} because there are two Si atoms for every three O atoms. The —SiO_{3/2} structure of this organosilicon polymer has properties similar to that of silica (SiO₂) composed of multiple siloxane bonds.

In the partial structure represented by formula (1), R is preferably a C₁₋₆ alkyl group, or more preferably a C₁₋₃ alkyl group.

Desirable examples of C₁₋₃ alkyl groups include methyl, ethyl and propyl groups, and R is more preferably a methyl group.

The organosilicon polymer is preferably a condensation polymer of an organosilicon compound having a structure represented by formula (Z) below:

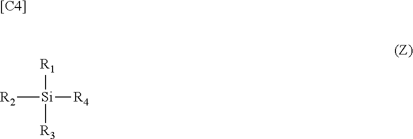

(in formula (Z), R₁ represents a C₁₋₆ hydrocarbon group (preferably an alkyl group), and each of R₂, R₃ and R₄ independently represents a halogen atom, hydroxy group, acetoxy group or alkoxy group).

R₁ is preferably a C₁₋₃ aliphatic hydrocarbon group, or more preferably a methyl group.

Each of R₂, R₃ and R₄ independently represents a halogen atom, hydroxy group, acetoxy group or alkoxy group (hereunder also called a reactive group). These reactive groups form crosslinked structures by hydrolysis, addition polymerization and condensation polymerization.

From the standpoint of gentle hydrolysis at room temperature and precipitation on the surface of the toner base particle, a C₁₋₃ alkoxy group is preferred, and a methoxy or ethoxy group is more preferred.

The hydrolysis, addition polymerization or condensation polymerization of R₂, R₃ and R₄ can be controlled by means of the reaction temperature, reaction time, reaction solvent and pH. Either one kind or a combination of multiple kinds of organosilicon compounds (hereunder also called trifunctional silanes) having three reactive groups (R₂, R₃ and R₄) in the molecule apart from R₁ in the formula (Z) above can be used to obtain the organosilicon polymer used in the invention.

Examples of the compound represented by formula (Z) above include the following: trifunctional methyl silanes such as methyl trimethoxysilane, methyl triethoxysilane, methyl diethoxymethoxysilane, methyl ethoxydimethoxysilane, methyl trichlorosilane, methyl methoxydichlorosilane, methyl ethoxydichlorosilane, methyl dimethoxychlorosilane, methyl methoxyethoxychlorosilane, methyl diethoxychlorosilane, methyl triacetoxysilane, methyl diacetoxymethoxysilane, methyl diacetoxyethoxysilane, methyl acetoxydimethoxysilane, methyl acetoxymethoxyethoxysilane, methyl acetoxydiethoxysilane, methyl trihydroxysilane, methyl methoxydihydroxysilane, methyl ethoxydihydroxysilane, methyl dimethoxyhydroxysilane, methyl ethoxymethoxyhydroxysilane and methyl diethoxyhydroxysilane;

trifunctional silanes such as ethyl trimethoxysilane, ethyl triethoxysilane, ethyl trichlorosilane, ethyl triacetoxysilane, ethyl trihydroxysilane, propyl trimethoxysilane, propyl triethoxysilane, propyl trichlorosilane, propyl triacetoxysilane, propyl trihydroxysilane, butyl trimethoxysilane, butyl triethoxysilane, butyl trichlorosilane, butyl triacetoxysilane, butyl trihydroxysilane, hexyl trimethoxysilane, hexyl triethoxysilane, hexyl trichlorosilane, hexyl triacetoxysilane and hexyl trihydroxysilane; and

trifunctional phenyl silanes such as phenyl trimethoxysilane, phenyl triethoxysilane, phenyl trichlorosilane, phenyl triacetoxysilane and phenyl trihydroxysilane.

An organosilicon compound obtained by combining the following with an organosilicon compound having the structure represented by formula (Z) can also be used as long as it does not detract from the effects of the invention: an organosilicon compound having four reactive groups in the molecule (tetrafunctional silane), an organosilicon compound having two reactive groups in the molecule (bifunctional silane) or an organosilicon compound having one reactive group (monofunctional silane).

Examples include the following: dimethyl diethoxysilane, tetraethoxysilane, hexamethyl disilazane, 3-aminopropyl trimethoxysilane, 3-aminopropyl triethoxysilane, 3-(2-aminoethyl) aminopropyl trimethoxysilane, 3-(2-aminoethyl) aminopropyl triethoxysilane, and trifunctional vinyl silanes such as vinyl triisocyanatosilane, vinyl trimethoxysilane, vinyl triethoxysilane, vinyl diethoxymethoxysilane, vinyl ethoxydimethoxysilane, vinyl ethoxydihydroxysilane, vinyl dimethoxyhydroxysilane, vinyl ethoxymethoxyhydroxysilane and vinyl diethoxyhydroxysilane.

The content of the organosilicon polymer in the toner particle is preferably from 1.0 mass % to 10.0 mass %.

A preferred method of forming the aforementioned specific convex shape on the toner particle surface is to disperse the toner base particle in an aqueous medium to obtain a toner base particle dispersion, and then add an organosilicon polymer to this dispersion to form the convex shape and obtain a toner particle dispersion.

The solids concentration of the toner base particle dispersion is preferably adjusted to from 25 mass % to 50 mass %. It is also desirable to adjust the temperature of the toner base particle dispersion to at least 35° C. Furthermore, the pH of the toner base particle dispersion is preferably adjusted to a pH at which condensation of the organosilicon polymer does not progress easily. Because the pH at which condensation of the organosilicon polymer does not progress easily differs according to the substance, a pH within ±0.5 of the pH at which the reaction is least likely to progress is preferred.

The organosilicon compound is preferably one that has been subjected to hydrolysis treatment. For example, the organosilicon compound is hydrolyzed in advance in a separate container as a pre-treatment. The charge concentration for hydrolysis is preferably from 40 to 500 mass parts, or more preferably from 100 to 400 mass parts of water such as ion-exchange water or RO water from which ion components have been removed given 100 mass parts as the amount of the organosilicon compound. The hydrolysis conditions are preferably a pH of 2 to 7, a temperature of 15° C. to 80° C. and a time of 30 to 600 minutes.

The resulting hydrolysis solution is mixed with the toner base particle dispersion, and the mixture is adjusted to a suitable pH for condensation (preferably 6 to 12, or 1 to 3, or more preferably 8 to 12). The amount of the hydrolysis solution is adjusted to 5.0 to 30.0 mass parts of the organosilicon compound per 100 mass parts of the toner base particle to facilitate formation of a convex shape. The temperature and time for forming and condensing the convex shape are preferably 35° C. to 99° C. and 60 minutes to 72 hours.

When controlling the convex shape on the toner particle surface, the pH is preferably adjusted in two stages. The convex shape on the toner particle surface can be controlled by suitably adjusting the holding time before pH adjustment and the holding time before the second-stage pH adjustment when condensing the organosilicon compound. For example, the pH is preferably maintained at pH 4.0 to 6.0 for 0.5 to 1.5 hours, and then maintained at pH 8.0 to 11.0 for 3.0 to 5.0 hours. The convex shape can also be controlled by adjusting the condensation temperature of the organic compound within the range of 35° C. to 80° C.

For example, the protrusion width w can be controlled by controlling the added amount of the organosilicon compound, the reaction temperature, and the reaction pH and reaction time during the first stage. For example, the protrusion width tends to be larger when the reaction time in the first stage is longer.

Furthermore, the protrusion diameter d and protrusion width h can be controlled by controlling the added amount of the organosilicon compound, the reaction temperature, the pH in the second stage and the like. For example, the higher the reaction pH in the second stage, the protrusion diameter d and protrusion height h tend to be greater.

Specific methods for manufacturing the toner are explained below, but these are not limiting.

It is desirable to manufacture the toner base particle in an aqueous medium and then form protrusions containing an organosilicon polymer on the surface of the toner base particle.

A suspension polymerization method, dissolution suspension method or emulsion aggregation method is preferred as the toner base particle manufacturing method, and a suspension polymerization method is more preferred. With a suspension polymerization method, it is easy to deposit the organosilicon polymer can uniformly on the surface of the toner base particle, resulting in excellent adhesion of the organosilicon polymer, good environmental stability and suppression of charge reversal components, as well as long-term continuation of these effects. Suspension polymerization is explained further below.

In suspension polymerization, a polymerizable monomer composition containing a polymerizable monomer for producing a binder resin together with additives such as colorants as necessary is granulated in an aqueous medium to thereby polymerize the polymerizable monomer contained in the polymerizable monomer composition and product a toner base particle.

A release agent and another resin can also be added to the polymerizable monomer composition as necessary. After completion of the polymerization step, the resulting particle can be washed by known methods and collected by filtration. The temperature may also be raised during the second half of the polymerization step. Part of the dispersion medium may also be distilled off during the second half of the polymerization step or after completion of the polymerization step to remove unreacted polymerizable monomers or by-products.

Using the toner base particle thus obtained, protrusions of an organic silicon polymer are preferably formed by the methods described above.

A release agent may be used in the toner. Examples of release agents include the following: petroleum waxes such as paraffin wax, microcrystalline was and petrolatum, and their derivatives, montan wax and its derivatives, hydrocarbon waxes obtained by Fischer-Tropsch methods, and their derivatives, polyolefin waxes such as polyethylene and polypropylene, and their derivatives, natural waxes such as carnauba wax and candelilla wax, and their derivatives, higher fatty alcohols, fatty acids such as stearic acid and palmitic acid, or acid amides, esters or ketones of these, hardened castor oil and its derivatives, and vegetable waxes, animal waxes and silicone resins. Derivatives here include oxides, block copolymers with vinyl monomers, and graft modified products. One release agent alone or a mixture of multiple kinds may be used. The content of the release agent is preferably from 2.0 to 30.0 mass parts per 100 mass parts of the binder resin or the polymerizable monomer for producing the binder resin.

Other resins that can be used include the following: monopolymers of styrenes and substituted styrenes such as polystyrene and polyvinyl toluene; styrene copolymers such as styrene-propylene copolymer, styrene-vinyl toluene copolymer, styrene-vinyl naphthalene copolymer, styrene-methyl acrylate copolymer, styrene-ethyl acrylate copolymer, styrene-butyl acrylate copolymer, styrene-octyl acrylate copolymer, styrene-dimethylaminoethyl acrylate copolymer, styrene-methyl methacrylate copolymer, styrene-ethyl methacrylate copolymer, styrene-butyl methacrylate copolymer, styrene-dimethylaminoethyl methacrylate copolymer, styrene-vinyl methyl ether copolymer, styrene-vinyl ethyl ether copolymer, styrene-vinyl methyl ketone copolymer, styrene-butadiene copolymer, styrene-isoprene copolymer, styrene-maleic acid copolymer and styrene-maleic acid ester copolymer; and polymethyl methacrylate, polybutyl methacrylate, polyvinyl acetate, polyethylene, polypropylene, polyvinyl butyral, silicone resin, polyester resin, polyamide resin, epoxy resin, polyacrylic resin, rosin, modified rosin, terpene resin, phenol resin, aliphatic or alicyclic hydrocarbon resins, and aromatic petroleum resins. One of these or a mixture of multiple kinds may be used.

The following vinyl polymerizable monomers may be used favorably as polymerizable monomers: styrene; styrene derivatives such as α-methylstyrene, β-methylstyrene, o-methyl styrene, m-methyl styrene, p-methyl styrene, 2,4-dimethylstyrene, p-n-butyl styrene, p-tert-butyl styrene, p-n-hexyl styrene, p-n-octyl styrene, p-n-nonylstyrene, p-n-decylstyrene, p-n-dodecyl styrene, p-methoxystyrene and p-phenylstyrene; acrylic polymerizable monomers such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octylacrylate, n-nonylacrylate, cyclohexyl acrylate, benzyl acrylate, dimethyl phosphate ethyl acrylate, diethyl phosphate ethyl acrylate, dibutyl phosphate ethyl acrylate and 2-benzoyloxyethyl acrylate; methacrylic polymerizable monomers such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate and dibutyl phosphate ethyl methacrylate; methylene aliphatic monocarboxylic acid esters; vinyl esters such as vinyl acetate, vinyl propionate, vinyl benzoate, vinyl butyrate, vinyl benzoate and vinyl formate; vinyl ethers such as vinyl methyl ether, vinyl ethyl ether and vinyl isobutyl ether; and vinyl methyl ketone, vinyl hexyl ketone and vinyl isopropyl ketone. Of these vinyl polymers, styrene and styrene derivatives, acrylic polymerizable monomers and methacrylic polymerizable monomers are preferred.

A polymerization initiator may also be added when polymerizing the polymerizable monomer. Examples of polymerization initiators include the following: azo and diazo polymerization initiators such as 2,2′-azobis-(2,4-divaleronitrile), 2,2′-azobisisobutyronitrile, 1,1′-azobis(cyclohexane-1-carbonitrile), 2,2′-azobis-4-methoxy-2,4-dimethylvaleronitrile and azobisisobutyronitrile; and peroxide polymerization initiators such as benzoyl peroxide, methyl ethyl ketone peroxide, diisopropyl oxycarbonate, cumene hydroperoxide, 2,4-dichlorobenzoyl peroxide and lauroyl peroxide. These polymerization initiators are preferably added in the amount of 0.5 to 30.0 mass parts per 100 mass parts of the polymerizable monomer, and one or multiple kinds may be used.

A chain transfer agent may also be added when polymerizing the polymerizable monomer to control the molecular weight of the binder resin constituting the toner base particle. The added amount thereof is preferably 0.001 to 15.000 mass parts per 100 mass parts of the polymerizable monomer.

A crosslinking agent may also be added when polymerizing the polymerizable monomer to control the molecular weight of the binder resin constituting the toner base particle.

Examples include divinyl benzene, bis(4-acryloxypolyethoxyphenyl) propane, ethylene glycol diacrylate, 1,3-butylene glycol diacrylate, 1,4-butanediol diacrylate, 1,5-pentanediol diacrylate, 1,6-hexanediol diacrylate, neopentyl glycol diacrylate, diethylene glycol diacrylate, triethylene glycol diacrylate, tetraethylene glycol diacrylate, diacrylates of polyethylene glycol #200, #400 and #600, dipropylene glycol diacrylate, polypropylene glycol diacrylate, polyester diacrylate (MANDA, Nippon Kayaku), and these acrylates converted to methacrylates.

Examples of polyfunctional crosslinkable monomers include the following: pentaerythriol triacrylate, trimethylol ethane triacrylate, trimethylol propane triacrylate, tetramethylol methane tetraacrylate, oligoester acrylate and methacrylate, 2,2-bis(4-methacryloxy-polyethoxyphenyl) propane, diacryl phthalate, triallyl cyanurate, triallyl isocyanurate, triallyl trimellitate and diaryl chlorendate.

The added amount thereof is preferably from 0.001 to 15.000 mass parts per 100 mass parts of the polymerizable monomer.

When the medium used in suspension polymerization is an aqueous medium, the following may be used as dispersion stabilizers for the particles of the polymerizable monomer composition: tricalcium phosphate, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica and alumina.

The following may also be used as organic system dispersants: polyvinyl alcohol, gelatin, methyl cellulose, methyl hydroxypropyl cellulose, ethyl cellulose, carboxymethyl cellulose sodium salt, and starch.

A commercial nonionic, anionic or cationic surfactant may also be used. Examples of such surfactants include sodium dodecylsulfate, sodium tetradecylsulfate, sodium pentadecylsulfate, sodium octylsulfate, sodium oleate, sodium laurate and potassium stearate.

A colorant may also be used in the toner, and a known colorant may be used without any particular limitations. The content of the colorant is preferably from 3.0 to 15.0 mass parts per 100 mass parts of the binder resin or the polymerizable monomer for producing the binder resin.

A charge control agent may also be used when manufacturing the toner, and known charge control agents may be used. The added amount of these charge control agents is preferably from 0.01 to 10.00 mass parts per 100 mass parts of the binder resin or polymerizable monomer.

The toner particle may be used as is as a toner, but various organic or inorganic fine powders may also be externally added as necessary. From the standpoint of durability when added to the toner particle, the organic or inorganic fine powders preferably have a particle diameter of not more than 1/10 the weight-average particle diameter of the toner particle. For example, the following may be used as organic or inorganic fine powders.

(1) Flowability imparting agents: silica, alumina, titanium oxide, carbon black, carbon fluoride

(2) Abrasives: metal oxides (such as strontium titanate, cerium oxide, alumina, magnesium oxide and chromium oxide), nitrides (such as silicon nitride), carbides (such as silicon carbide) and metal salts (such as calcium sulfate, barium sulfate and calcium carbonate)

(3) Lubricants: fluorine resin powders (such as vinylidene fluoride and polytetrafluoroethylene) and fatty acid metal salts (such as zinc stearate and calcium stearate)

(4) Charge control uniticles: metal oxides (such as tin oxide, titanium oxide, zinc oxide, silica and alumina) and carbon black

The organic or inorganic fine powders may also be surface treated to improve flowability and give the toner a uniform charge. Examples of treatment agents for hydrophobically treating the organic or inorganic fine powders include unmodified silicon varnish, various kinds of modified silicon varnish, unmodified silicone oil, various kinds of modified silicone oil, silane compounds, silane coupling agents, other organic silicon compounds, and organic titanium compounds. One of these treatment agents alone or a combination of multiple kinds may be used.

The various measurement methods related to the present invention are explained below.

### Methods for Observing Toner Cross-Section by Scanning Transmission Electron Microscopy (STEM)

A toner cross-section for observation by scanning transmission electron microscopy (STEM) is prepared as follows. The toner cross-section preparation steps are explained below.

The toner is first sprayed as a single layer on a cover glass (Matsunami Glass Ind., Ltd. square cover glass: Square No. 1), and an osmium plasma coater (Filgen, Inc. OPC80T) is used to apply an Os coat (5 nm) and a naphthalene coat (20 nm) as protective coats.

A PTFE tube (ϕ 1.5 mm×ϕ3 mm×3 mm) is filled with D800 photocurable resin (JEOL Ltd.), and the above cover glass is placed gently on the tube so that the toner contacts the D800 photocurable resin. The resin is cured by exposing it to light in this state, and the cover glass and tube are removed to form a cylindrical resin with toner embedded in the outermost surface. This is cut with an ultrasonic ultramicrotome (Leica, UC7) at a cutting speed of 0.6 mm/s to just the length of the toner radius (such as 4.0 microns if the weight-average particle diameter (D4) is 8.0 microns) from the outermost surface of the cylindrical resin, exposing the center of the toner in cross-section.

This is then cut to a film thickness of 100 nm to prepare a thin sample of the toner cross-section. Cross-sections of the center of the toner can be obtained by cutting by these methods.

Images are obtained with a STEM probe size of 1 nm and an image size of 1024×1024 pixels. On the bright field image Detector Control panel, the Contrast is adjusted to 1425 and the Brightness to 3750, while on the Image Control panel the Contrast is adjusted to 0.0, the Brightness to 0.5 and the Gamma to 1.00, and images are obtained. Image capture is performed at an image magnification of 100,000× covering from about one-fourth to one-half of the cross-sectional circumference of one toner particle as shown in FIG. 4. The resulting images are analyzed with image processing software (Image J, available from https://imagej/nih.gov/ij/), and protrusions containing the organosilicon polymer are measured. Image analysis is performed on 30 STEM images.

First, a line tracing the periphery of the toner base particle is drawn with a line drawing tool (select Segmented Line in Straight tab). In places where the protrusions of the organosilicon polymer are embedded in the toner base particle, the line is continued smoothly as though there were no embedding. The image is converted to a horizontal image based on this line (select Selection in Edit tab, convert line width to 500 pixels in Properties, then select Selection in Edit tab and perform Straightener). The protrusion width w, protrusion diameter d and protrusion height h of each of the individual protrusions containing the organosilicon polymer in the horizontal image are measured by the methods described above. P(d/w) is calculated based on the measurement results from 30 STEM images. The cumulative distribution of the protrusion heights h is also taken to calculate h80.

Furthermore, the total of the protrusion widths w of protrusions with a protrusion height h of 40 nm to 300 nm in the horizontal image used for image analysis is given as Σw, and used for image analysis is given as the peripheral length L. The width of the horizontal image corresponds to the length of the surface of the toner base particle in the STEM image. Σw/L is calculated for each image, and the arithmetic mean of 30 STEM images is calculated.

Detailed protrusion measurement is as explained above and as shown in FIGS. 5 to 7. Measurement is performed with Image J by overlaying the scale on the image with Straight Line on the Straight tab, and setting the length of the scale on the image with Set Scale on the Analyze tab. A line segment corresponding to the protrusion width w or protrusion height h can be drawn with Straight Line on the Straight tab, and measured with the Measure function of the Analyze tab.

Method for Calculating Average Diameter of Protrusions in Scanning Electron Microscopy (SEM)

The SEM measurement methods are as follows. Images taken with a Hitachi S-4800 ultra-high-resolution field emission scanning electron microscope (Hitachi High Technologies) are used. The S-4800 imaging conditions are as follows.

(1) Sample Preparation

A sample stand (15 mm×6 mm aluminum sample stand) is thinly coated with conductive paste (Ted Pella, Inc., Product No. 16053, PELCO Colloidal Graphite, Isopropanol base), and the toner is blown onto this. This is then air blown to remove excess fine particles from the sample stand, and platinum is vapor deposited for 15 seconds at 15 mA. The sample stand is set in a sample holder, and the height of the sample stand is adjusted to 30 mm with a sample height gauge.

(2) S-4800 Observation Condition Settings

An anticontamination trap attached to the housing of the S-4800 is filled to overflowing with liquid nitrogen and left for 30 minutes. “PC-SEM” is started on the S-4800 to perform flushing (purification of FE chip electron source). The acceleration voltage display part of the control panel is clicked on the image, and the [Flushing] button is pressed to open a flushing execution dialog. This is executed after confirming that the flushing strength is 2. The emission current generated by flushing is then confirmed to be 20 to 40 μA. The sample holder is inserted in the sample chamber of the S-4800 housing. [Origin] is pressed on the control panel to move the sample holder to the observation position.

The acceleration voltage display part is clicked to open an HV settings dialog, and the acceleration voltage is set to [2.0 kV] and the emission current to [10 μA]. In the [Basic] tab of the operations panel, signal selection is set to [SE] and the [Lower (L)] SE detector is selected to enter the mode for backscattered electron image observation. In the same [Basic] tab of the operations panel, the probe current of the electron optics condition block is set to [Normal], the focus mode to [UHR], and the WD to [8.0 mm]. The [ON] button of the acceleration voltage display part of the control panel is pressed to apply acceleration voltage.

(3) Focus Adjustment

The magnification is set to 5,000× (5 k) by dragging within the magnification display portion of the control panel. The [COARSE] focus knob of the operations panel is turned, and once the image is focused to some extent the aperture alignment is adjusted. [Align] is clicked on the control panel to display an alignment dialog, and [Beam] is selected. The STIGMA/ALIGNMENT knobs (X,Y) on the operations panel are turned to move the displayed beam to the center of the concentric circles.

[Aperture] is then selected, and the STIGMA/ALIGNMENT knobs (X,Y) are turned one by one to stop or minimize the movement of the image. The aperture dialog is closed, and the device is focused in autofocus. The operation is repeated two more times to focus the device. The magnification is set to 10,000× (10 k) by dragging within the magnification display portion of the control panel with the center of the maximum diameter of the observed particle aligned with the center of the measurement screen. The [COARSE] focus knob on the operations panel is turned, and the aperture alignment is adjusted once the device is focused to some extent. [Align] is clicked on the control panel to display an alignment dialog, and [Beam] is selected. The STIGMA/ALIGNMENT knobs (X,Y) on the operations panel are turned to move the displayed beam to the center of the concentric circles.

[Aperture] is then selected, and the STIGMA/ALIGNMENT knobs (X,Y) are turned one by one to stop or minimize the movement of the image. The aperture dialog is closed, and the device is focused in autofocus. The magnification is then set to 50,000× (50 k), the focus is adjusted again using the focus knob and STIGMA/ALIGNMENT knobs as before, and the device is focused again in autofocus. This operation is repeated again to focus the device.

(4) Image Storage

The brightness is adjusted in ABC mode, and 640×480 pixel sized photographs are taken and stored. Based on the resulting SEM images, the number-average diameter (D1) of 500 protrusions 20 nm or more in size on the toner particle surface is calculated with “Image J” image processing software. The measurement methods are as follows.

Measuring Number-Average Diameter of Protrusions of Organosilicon Polymer

The protrusions and toner base particle in the image are binarized by particle analysis and color coded. Next, the maximum length of the selected shape is selected from the measurement commands, and the protrusion radius R (maximum radius) of one protrusion is measured. This operation is performed multiple times and the arithmetic mean of 500 protrusions is determined to calculate the number-average of the protrusion radius R.

Method for Measuring Adhesion Rate of Organosilicon Polymer

160 g of sucrose (Kishida Chemical Co., Ltd.) is added to 100 ml of ion-exchange water and dissolved while using a hot water bath to prepare a concentrated sucrose solution. 31 g of this concentrated sucrose solution and 6 ml of Contaminon N (a 10 mass % aqueous solution of a pH 7 neutral detergent for cleaning precision instruments, consisting of a nonionic surfactant, an anionic surfactant and an organic builder, manufactured by Wako Pure Chemical Industries, Ltd.) are placed in a 50 ml centrifuge tube to prepare a dispersion solution. 1.0 g of toner is added to this dispersion solution, and clumps of toner are broken up with a spatula or the like.

The centrifuge tube is shaken for 20 minutes in a shaker at 350 spm (strokes per minute). After shaking, the solution is transferred to a glass tube (capacity 50 ml) of a swing rotor, and separated under conditions of 3,500 rpm, 30 minutes with a centrifuge (H-9R, Kokusan Co., Ltd.). Thorough separation of the toner and aqueous solution is confirmed visually, and the separated toner in the uppermost layer is collected with a spatula or the like. The aqueous solution containing the collected toner is filtered with a vacuum filter and then dried for at least 1 hour in a drier. The dried product is broken up with a spatula, and the amount of silicon is measured by fluorescent X-ray. The adhesion rate (%) is calculated from the measured element ratios of the washed toner and initial toner.

Fluorescent X-ray measurement of each element is performed in accordance with JIS K 0119-1969, specifically as follows.

An Axios wavelength dispersive fluorescent x-ray analyzer (PANalytical) is used as the measurement device together with the dedicated SuperQ ver. 4.0F software (PANalytical) for setting the measurement conditions and analyzing the measurement data. Rh is used for the anode of the X-ray tube, with vacuum as the measurement atmosphere and a measurement diameter (collimator diameter) of 10 mm and a measurement time of 10 seconds. A proportional counter (PC) is used for detection when measuring light elements, and a scintillation counter (SC) when measuring heavy elements.

For the measurement samples, about 1 g each of the washed toner and initial toner are placed in a dedicated aluminum pressing ring 10 mm in diameter, spread flat, and pressed for 60 seconds at 20 MPa with a BRE-32 tablet molding compressor (Maekawa Testing Machine MFG, Co., LTD.) to mold roughly 2 mm-thick pellets.

Measurement is performed under the above conditions, the elements are identified based on their peak positions in the resulting X-ray, and the concentrations are calculated from the count rate (unit: cps), which is the number of X-ray photons per unit time.

To quantify the elements in the toner, for example in the case of silicon 0.5 mass parts of silica (SiO₂) fine powder are added to 100 mass parts of the toner particle, and thoroughly mixed with a coffee mill. 2.0 mass parts and 5.0 mass parts of the silica fine particle are similarly mixed with the toner particle, and these are used as samples for preparing a calibration curve.

Using each of the samples, sample pellets for the calibration curve are prepared as above using a tablet molding compressor, and the count rate (unit: cps) of Si-Kα rays observed at a diffraction angle (2θ) of 109.08° using a PET spectral crystal is measured. The acceleration voltage and current value of the X-ray generating unit are set to 24 kV and 100 mA, respectively. The resulting X-ray count rate is plotted on the vertical axis and the added amount of SiO₂ in the calibration curve sample on the horizontal axis to obtain a calibration curve of linear function.

Next, the toner to be analyzed is made into a pellet as above using a tablet molding compressor, and the count rate of Si-Kα rays is measured. The content of the organosilicon polymer in the toner is then determined from the above calibration curve. The ratio of the amount of the element in the washed toner to the amount in the initial toner as calculated by the above methods is given as the adhesion rate (%).

Toner T Manufacturing Examples

Specific examples of the invention are explained below using manufacturing examples of the toner T, but these manufacturing examples do not limit the invention. “Parts” of the various materials used in manufacture are all based on mass unless otherwise specified.

Toner T Manufacturing Example

### Aqueous Medium 1 Preparation Step

650.0 parts of ion-exchange water and 14.0 parts of sodium phosphate (Rasa Industries Ltd, 12-hydrate) were placed in a reaction vessel equipped with a stirrer, a thermometer and a return pipe, and maintained for 1.0 hours at 65° C. as the system was purged with nitrogen. This was stirred at 15,000 rpm with a T.K. Homomixer (Tokushu Kika Kogyo Co., Ltd.) as a calcium chloride aqueous solution of 9.2 parts of calcium chloride (dihydrate) dissolved in 10.0 parts of ion-exchange water was added all at once to prepare an aqueous medium containing a dispersion stabilizer. 10 mass % hydrochloric acid was further added to the aqueous medium to adjust the pH to 5.0 and obtain an aqueous medium 1.

Polymerizable Monomer Composition Preparation Step
Styrene: 60.0 parts
C.I. pigment blue 15:3: 6.5 parts

These materials were placed in an attritor (Mitsui Miike Machinery Co., Ltd.), and dispersed for 5.0 hours at 220 rpm using zirconia beads 1.7 mm in diameter to prepare a pigment dispersion. The following materials were added to this pigment dispersion.
Styrene: 20.0 parts
n-butyl acrylate: 20.0 parts
Crosslinking agent (divinyl benzene): 0.3 parts
Saturated polyester resin: 5.0 parts

(Condensation polymer of propylene oxide modified bisphenol A (2-mol adduct) and terephthalic acid (molar ratio 10:12), glass transition temperature Tg=68° C., weight-average molecular weight Mw=10,000, molecular weight distribution Mw/Mn=5.12)
Fischer-Tropsch wax (melting point 78° C.): 7.0 parts

This was maintained at 65° C., and uniformly dissolved and dispersed at 500 rpm with a T.K. Homomixer (Tokushu Kika Kogyo Co., Ltd.) to prepare a polymerizable monomer composition.

Granulation Step

The temperature of the aqueous medium 1 was maintained at 70° C. and the rotation speed of the T.K. Homomixer at 15,000 rpm as the polymerizable monomer composition was added to the aqueous medium 1, and 10.0 parts of t-butyl peroxypivalate were added as a polymerization initiator. This was then maintained at 15,000 rpm in a stirring device and granulated for 10 minutes.

Polymerization and Distillation Step

Following the granulation step, the stirrer was replaced with a propeller stirring blade, the mixture was stirred at 150 rpm as polymerization was performed for 5.0 hours with the temperature maintained at 70° C., after which the temperature was raised to 85° C. and the mixture was heated for 2.0 hours to perform a polymerization reaction. The return pipe of the reaction vessel was then replaced with a cooling pipe, and the slurry was heated to 100° C. and distilled for 6 hours to distill of unreacted polymerizable monomers and obtain a toner base particle dispersion.

Polymerization of Organosilicon Compound

60.0 parts of ion-exchange water were measured into a reaction vessel equipped with a stirrer and a thermometer, and the pH was adjusted to 4.0 with 10 mass % hydrochloric acid. This was heated under stirring to adjust the temperature to 40° C. 40.0 parts of the organosilicon compound methyl triethoxysilane were then added and stirred for at least 2 hours to perform hydrolysis. Completion of hydrolysis was confirmed visually when the oil and water formed a single layer without separation, and the mixture was cooled to obtain a hydrolysis solution of the organosilicon compound.

The toner base particle dispersion was cooled to 55° C., after which 25.0 parts of the hydrolysis solution of the organosilicon compound were added to initiate polymerization of the organosilicon polymer. This was maintained for 15 minutes, after which the pH was adjusted to 5.5 with a 3.0% sodium hydrogen carbonate aqueous solution. Stirring was continued at 55° C. and maintained for 60 minutes, after which the pH was adjusted to 9.5 with a 3.0% sodium hydrogen carbonate aqueous solution and maintained for 240 minutes to obtain a toner particle dispersion.

Washing and Drying Step

Upon completion of the polymerization step, the toner particle dispersion was cooled, hydrochloric acid was added to adjust the pH to 1.5 or less, and the toner particle dispersion was left under stirring for 1 hour and then subjected to solid-liquid separation in a pressure filter to obtain a toner cake. This was re-slurried with ion-exchange water to again obtain a dispersion and subjected to solid-liquid separation in the above filter to obtain a toner cake.

The resulting toner cake was dried and classified for 72 hours in a 40° C. thermostatic tank to obtain a toner particle T.

Initial Preparatory Operation Control

The initial preparatory operation control that is a feature of the present invention is explained next.

The main body of the image forming apparatus of this example performs an initial preparatory operation control when a new process cartridge is installed and the photosensitive drum of the process cartridge is rotationally driven for the first time. In this example, the initial preparatory operation control consists of control to reduce the necessary motor output when the process cartridge first rotationally drives the photosensitive drum. By performing this control, it is possible to reduce the drive load during drive initiation of a new process cartridge. It is also possible to reduce the output necessary for the motor to rotationally drive the photosensitive drum, thereby contributing to motor size reduction and cost reduction.

FIG. 13 is a block diagram showing the control configuration of the image forming apparatus of the example. FIG. 13 does not show the entire control configuration of the image forming apparatus of the invention, but only the part relating to the characteristic configuration of the invention. Control portion 101, which comprises a CPU, memory or the like, controls the image forming operations of the image forming apparatus 100 in response to image data and print instructions received from an external device such as a host computer. That is, the various operations of the image forming operation explained here are controlled by the control portion 101.

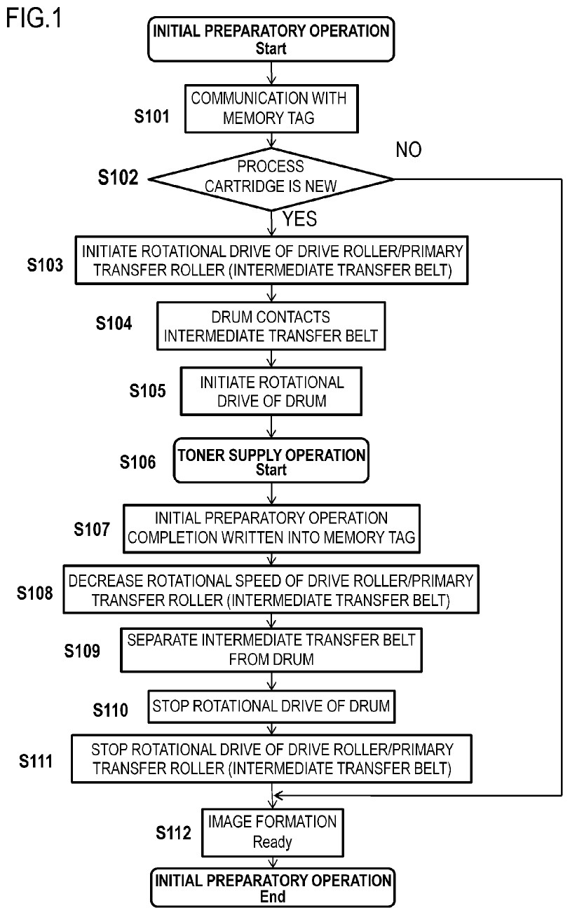

FIG. 1 shows the sequence of the initial preparatory operation control in this example, and the actual control is explained in detail here.

S101: Control portion 101 of the main body of the apparatus communicates via a reading portion with a memory tag installed in the process cartridge 7.

S102: The control portion 101 judges whether or not the process cartridge 7 is new (unused) based on use history data and the like recorded in the memory tag. The sequence proceeds to S103 if the answer is YES and to S112 if the answer is NO.

S103: The drive roller of the intermediate transfer belt 5 begins to be rotationally driven by rotational drive force provided by a motor M5 as second drive unit, and the intermediate transfer belt 5 rotates (in a first rotational speed) as a rotating member. The primary transfer roller 8 also begins to be rotationally driven by rotational drive force provided by a motor M8 as drive unit. The rotational speeds (surface movement speeds) of the intermediate transfer belt 5 and primary transfer roller 8 were set here at a peripheral speed ratio of 105% relative to the rotational speed (surface movement speed) of the photosensitive drum 1. By making the peripheral speed ratio greater than the peripheral speed ratio of 101.5% during image formation, it is possible to reduce the output of the motor M1 for driving the photosensitive drum 1 when rotational drive (in a third rotational speed) of the photosensitive drum 1 is initiated in step S105 (the third rotational speed is smaller than the first rotational speed, in a peripheral speed). While the peripheral speed ratio is set at 105% in this example, it may be any that is greater than the peripheral speed ratio during image formation and is preferably not more than 120%. That is, the ratio of the surface movement speed of the intermediate transfer belt 5 to the surface movement speed of the photosensitive drum 1 is preferably somewhat greater than 1 and not more than 1.2 given 1 as the ratio during image formation. This is because the inventors' researches have shown that when the peripheral speed ratio exceeded 120%, the photosensitive drum 1 was occasionally damaged when foreign matter became mixed in between the intermediate transfer belt 5 and the photosensitive drum 1 or the like for example.

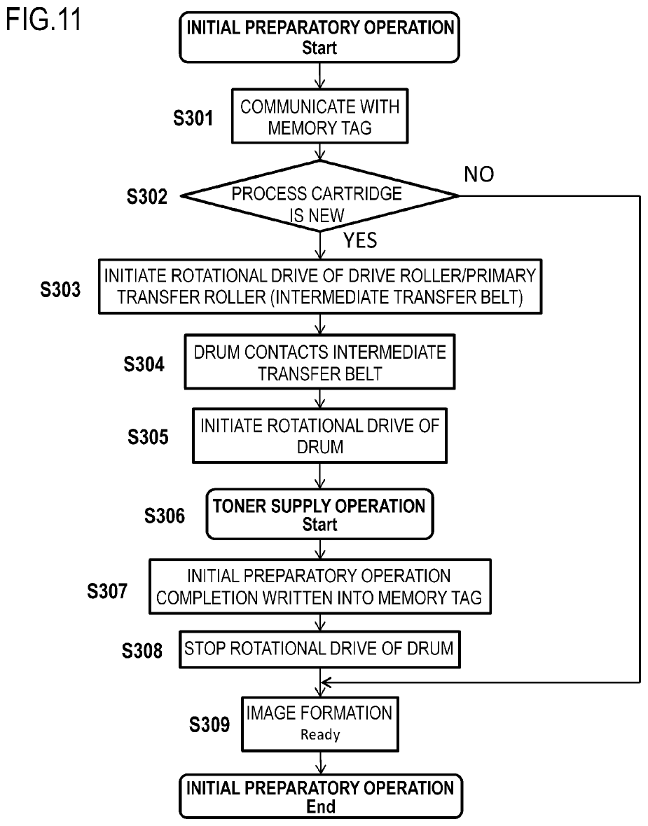

S104: The primary transfer roller 8 is moved into contact with the intermediate transfer belt 5 by the operation of the contact-separation mechanism shown in FIG. 11, thereby bringing the intermediate transfer belt 5 into contact with the photosensitive drum 1. In this process, the rotationally moving intermediate transfer belt 5 comes into contact with the unmoving photosensitive drum 1, which is not receiving any drive force from the motor M1. The image forming apparatus of this example is configured to allow the photosensitive drum 1 and intermediate transfer belt 5 to rub against each other in this state. The apparatus may also be configured to allow the photosensitive drum 1 to idle in conjunction with the intermediate transfer belt 5.

S105: The photosensitive drum 1 begins to be rotationally driven (in the third rotational speed) by rotational drive force provided by the motor M1 as first drive unit. When rotational drive of the photosensitive drum 1 is initiated, the intermediate transfer belt 5 exerts force on the photosensitive drum 1 in the rotating direction because the rotationally driven intermediate transfer belt 5 is already in contact with the photosensitive drum 1. Thus, as discussed above in step S103, it is possible to reduce the motor output required to drive the photosensitive drum 1.

S106: Toner supply operation control is performed as discussed below.

S107: The toner supply operation control is ended, toner is supplied as a lubricant to the photosensitive drum 1, and when this toner reaches the cleaning member 6, the completion of the initial preparatory operation as an operation to reduce the initial frictional force of the cleaning member 6 is written into the memory of the process cartridge 7. Since the process cartridge 7 does not require initial preparatory operation once the data about completion of the initial preparatory operation have been received, the cartridge is then judged not to be new in step S102.

S108: The toner supply operation control is ended, and toner is supplied as a lubricant to the photosensitive drum 1, and when this toner reaches the cleaning member 6, the frictional force of the cleaning member 6 is reduced. Because the load of the motor M1 for rotationally driving the photosensitive drum 1 is thus reduced, the rotational speed of the intermediate transfer belt 5 can be lowered from the first rotational speed to a second rotational speed (while the rotational speed of the photosensitive drum 1 is maintained in the third rotational speed), so that the peripheral speed ratio of the surface speed of the intermediate transfer belt 5 relative to the surface speed of the photosensitive drum 1 can then be returned to 101.5% (the second rotational speed is larger than the third rotational speed, in peripheral speed). Put another way, control to make the peripheral speed ratio greater during the initial preparation operation than during image formation is continued until the toner supplied to the photosensitive drum 1 by the toner supply operation reaches the contact position between the photosensitive drum 1 and the cleaning member 6.

In addition, by lowering the intermediate transfer belt 5 from the first rotational speed to the second rotational speed in S108, it is possible to prevent the rotational speed of the photosensitive drum 1 from becoming unstable in “a transitional period” when the intermediate transfer belt 5 is separated from the photosensitive drum 1. Therefore, by stabilizing the rotational speed of the photosensitive drum 1, vibration and load fluctuations on the motor M1 can be further suppressed.

S109: Before the rotational drive of the photosensitive drum 1 is stopped, the primary transfer roller 8 is separated to thereby separate the intermediate transfer belt 5 and the photosensitive drum 1.

S110: The rotational drive of the photosensitive drum 1 is stopped.

S111: The drive roller of the intermediate transfer belt 5 ceases rotational drive, stopping the intermediate transfer belt 5. The primary transfer roller 8 also ceases rotational drive.

S112: The system is now in a standby state in which image formation operation is possible (image formation Ready). However, if a print job is transmitted during the initial preparatory operation for example, an image forming operation may still be performed after the step S107, which completes the operation of reducing the initial frictional force.

In this example, the second rotational speed of the intermediate transfer belt 5 (the rotating member) in the preparatory operation is same as a rotational speed of the intermediate transfer belt 5 (the rotating member) in the image forming operation.

In this example, a rotational speed of the photosensitive drum 1 (the image bearing member) is constant (not changed) in the preparatory operation.

In this example, a rotational speed of the photosensitive drum 1 (the image bearing member) in the preparatory operation is same as a rotational speed of the photosensitive drum 1 (the image bearing member) in the image forming operation.

In this example, the peripheral speed ratio of the surface speed of the intermediate transfer belt 5 relative to the surface speed of the photosensitive drum 1 is set by changing a rotational speed of the intermediate transfer belt 5 while the rotational speed of the photosensitive drum is maintained constant. However, the peripheral speed ratio of the surface speed of the intermediate transfer belt 5 relative to the surface speed of the photosensitive drum 1 can be set by changing either one or both of the intermediate transfer belt 5 and the photosensitive drum 1.

In this example, a system of communicating with a memory tag installed in the process cartridge 7 is adopted as the means (detection unit) for judging whether the process cartridge 7 is new or not (use condition). However, the means of judging whether the process cartridge 7 is new or not is not necessarily limited to the method of this example, and the effects of this example can also be obtained with another method.

Moreover, in this example an intermediate transfer belt system is adopted as the transfer member, but similar effects can also be obtained with a system of direct transfer from the photosensitive drum 1 to a recording material such as paper as long as contact with the photosensitive drum 1 is possible during the initial preparatory operation. That is, depending on the configuration of the image forming apparatus, the rotating member that contacts the photosensitive drum 1 to assist with the rotational drive of the photosensitive drum 1 may be a transfer roller or paper conveyance (recording material conveyance) belt in a direct transfer system. In the configuration of such a direct transfer system, the photosensitive drum 1 and the rotating member contacting it are in constant contact without a contact-separation mechanism, but effects similar to those of the example can still be obtained by applying the present invention.

The toner supply operation control is explained next. The toner supply operation control is a control whereby toner is supplied from the developing unit 4 to the photosensitive drum 1, and this toner functions as a lubricant when it is then supplied along with the rotational drive of the photosensitive drum 1 to the point of contact between the cleaning member 6 and the photosensitive drum 1.

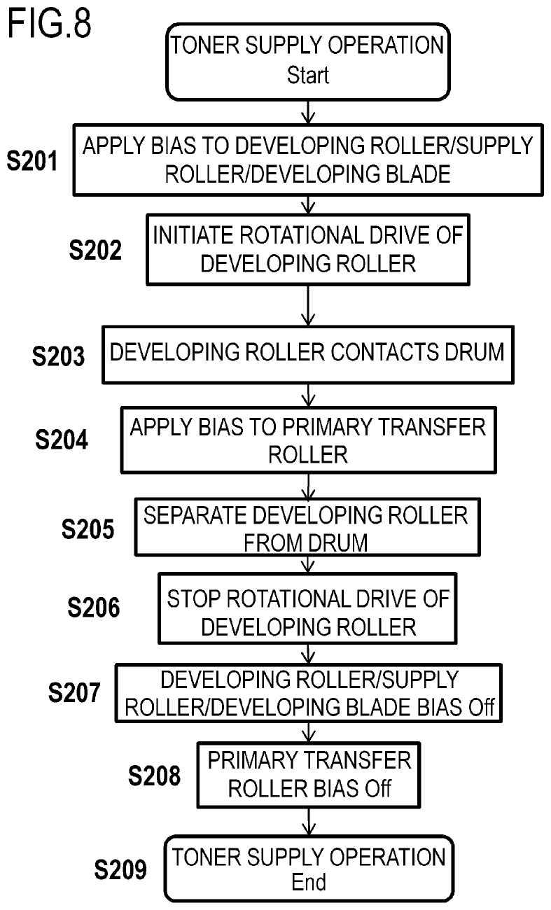

FIG. 8 shows the sequence of the toner supply operation control, and the actual operations are explained in detail here.

S201: Toner supply bias is applied by the developing bias source S4 to the supply roller 20 and the developing roller 17 of the developing unit 4, and by the blade bias source S6 to the developing blade 21. This toner supply bias may be any that allows the toner to be developed on the photosensitive drum 1, and in this example the bias applied to the developing blade 21 is −400 V, while the bias applied to the developing roller 17 and supply roller 20 is −300 V.

S202: The developing roller 17 of the developing unit 4 begins to be rotationally driven by rotational drive force supplied from the motor M4 as a drive source.

S203: The developing roller 17 contacts the photosensitive drum 1, initiating toner supply to the photosensitive drum 1.

S204: The toner suppled to the photosensitive drum 1 from the developing roller 17 is conveyed along with the rotation of the photosensitive drum 1, and −200 V is applied to the primary transfer roller 8 before the toner reaches the contact position with the intermediate transfer belt 5. The applied bias may be any that prevents the negatively charged toner from being transferred from the photosensitive drum 1 to the intermediate transfer belt 5 and causes the toner to be supplied efficiently to the contact position with the cleaning member 6.

S205: Once the photosensitive drum 1 has progressed a predetermined distance after contacting the developing roller 17 in step S203, the developing roller 17 is separated from the photosensitive drum 1. The predetermined distance may be any distance at which sufficient toner can be supplied to reduce the frictional force between the cleaning member 6 and the photosensitive drum 1. In this example, this is a width of 15 mm.

S206: The rotational drive of the developing roller 17 is stopped.

S207: The toner supply bias applied to the developing roller 17, supply roller 20 and developing blade 21 is turned to OFF.

S208: Once all of the supplied toner has passed through the contact position with the intermediate transfer belt 5 in conjunction with the rotational drive of the photosensitive drum 1, the bias applied to the primary transfer roller 8 is turned to OFF.

S209: The toner supply operation is completed, and the sequence returns to step S107 of the initial preparatory operation.

In this example, toner supply operation control is performed during the initial preparatory operation control when a new process cartridge is inserted. However, other controls may also be performed in parallel with this control or interposed during this control as necessary.

Furthermore, a case in which one new process cartridge is inserted for the first time is explained in this example for reasons of simplicity, but similar control can also be applied to each cartridge in cases in which multiple process cartridges are inserted at the same time for example. This is also applicable to a monochrome image forming device that presupposes the insertion of only one process cartridge for example.

Explanation of Motor Output Reduction

The motor output for driving the photosensitive drum can also be reduced using the configuration of this example, and this action is explained here.

Concerning the speeds during rotational drive of the photosensitive drum in initial preparatory operation control, the ratio of the surface speed of the intermediate transfer belt to the surface speed of the photosensitive drum (peripheral speed ratio) is set at 105% in this example.

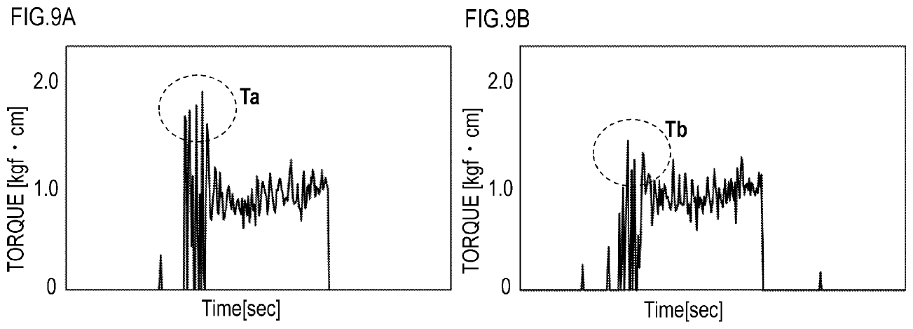

FIGS. 9A and 9B show a comparison of drive torques in this example (FIG. 9B) and a comparative example (FIG. 9A).

To confirm the effects of the example, the torque during drive initiation of the photosensitive drum was measured and compared with the torque during drive initiation without contact with the intermediate transfer belt as a comparative example. In FIGS. 9A and 9B, comparing Tb of the example with Ta of the comparative example, about 36% reduction was achieved.

In this example, different motors are used as the motor M5 for driving the intermediate transfer belt 5 (drive roller) and the motor M1 for driving the photosensitive drum 1. This means that the motor current of the motor M1 increases when the motor current of the motor M5 is reduced, but this ordinarily has little effect because the load for driving the intermediate transfer belt 5 is much greater than the load for driving the process cartridge 7. The inventors' researches have shown that there is a roughly 15-fold difference between the two, and the contribution of the motor M1 is also relatively small considering the design margin. Normally a motor is designed based on the expected maximum load, moreover, and in the case of the motor M1, reducing the drive for driving the new process cartridge 7 can contribute to reducing the motor size. In the case of the motor M5, on the other hand, because this corresponds to a region where there is a margin of output relative to the maximum load at least to the extent that there is no paper conveyance (recording material conveyance) during the initial preparatory operation, the present example contributes to dispersing the load in the region where there is a margin of motor output.

In comparison with conventional toners, the load can also be reduced in the present example even after the toner has been supplied by the toner supply operation control.

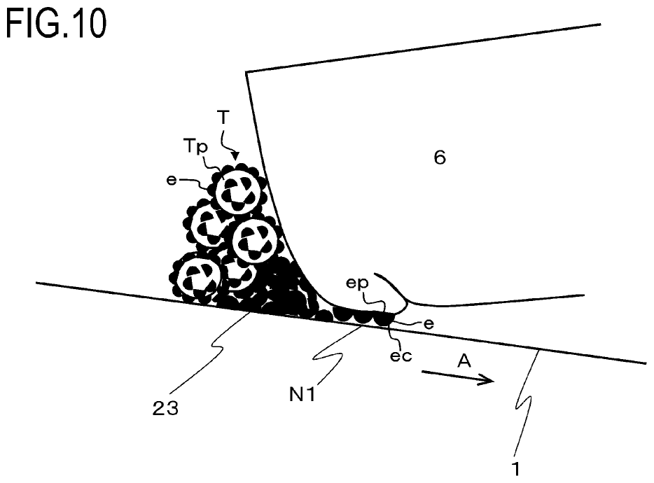

In this example, the drive torque is reduced by supplying toner having surface protrusions to the contact portion between the cleaning member and the photosensitive drum. The mechanism for this is explained in detail using FIG. 10.

FIG. 10 is an enlarged view of the contact portion between the photosensitive drum 1 and the cleaning member 6 and illustrates the vicinity of the cleaning nip N1 when the toner supply operation control has caused the toner T to be cleaned by the cleaning member 6. The toner (developer) T is made up of a toner base particle Tp and multiple protrusions e formed on the surface of the toner base particle Tp. When the toner T arrives at the cleaning member 6, at least some of the protrusions e formed on the toner T surface are transferred to the cleaning member 6 from the toner base particle Tp by the cleaning member 6 and by the shearing force between toner particles. Some of the transferred protrusions e are pushed against other transferred protrusions e by the cleaning member 6, moving them to the cleaning nip N1 where the flat portions ep of the protrusions e adhere to the side of the cleaning member 6. Protrusions e that have not been able to penetrate the cleaning nip N1 accumulate near the entrance to the cleaning nip N1, forming a deposit layer 23 of protrusions e.

Next, as shown in FIG. 10, in the case of the toner T used in this example protrusions e that have moved to other toner T particles, or to the cleaning member 6 or to the deposit layer 23 have flat portions ep and curved portions ec, and the flat portions ep of those transferred protrusions e that have penetrated the cleaning nip N1 adhere to the side of the cleaning member 6. As a result, the curved portions ec of the protrusions e contact the photosensitive drum 1, thereby reducing the contact position between the cleaning member 6 and the photosensitive drum 1. This makes it easier for the cleaning member 6 to slide against the surface of the photosensitive drum 1, reducing the drive torque of the photosensitive drum 1.

By using the toner T of this example, it is possible to reduce the motor output even after the intermediate transfer belt 5 and the photosensitive drum 1 have been separated in step S108.

Thus, with this example the motor output in a new cartridge can be reduced by increasing the peripheral speed ratio of the intermediate transfer belt relative to the photosensitive drum in the initial preparatory operation. It is also possible to reduce the motor output even after the initial preparatory operation by using the toner T.

### Example 2

Example 2 of the present invention differs from Example 1 in the configuration of the initial preparatory operation control. In Example 2, matters apart from this that overlap with Example 1 are the same as in Example 1, and detailed explanations are omitted.

FIG. 11 shows the sequence of the initial preparatory operation control in this example, and the actual control is explained here in detail.

S301: Control portion 101 of the main body of the apparatus communicates with a memory tag installed in the process cartridge 7.

S302: The control portion 101 judges whether or not the process cartridge 7 is new. The sequence proceeds to S303 if the answer is YES and to S309 if the answer is NO.

S303: The drive roller 51 of the intermediate transfer belt 5 begins rotational drive, and the intermediate transfer belt 5 rotates. The primary transfer roller 8 also begins rotational drive. The rotational speeds of (surface movement speeds) of the intermediate transfer belt 5 and the primary transfer roller 8 were set here to a peripheral speed ratio of 105% relative to the rotational speed (surface movement speed) of the photosensitive drum 1. By making the peripheral speed ratio greater than the peripheral speed ratio of 101.5% during image formation, it is possible to reduce the motor output for driving the photosensitive drum 1 when rotational drive of the photosensitive drum 1 is initiated in step S305.

S304: The primary transfer roller 8 causes the intermediate transfer belt 5 to contact the photosensitive drum 1.

S305: Rotational drive of the photosensitive drum 1 is initiated. When rotational drive of the photosensitive drum 1 is initiated, the motor output for driving the photosensitive drum 1 can be reduced as discussed above in S303 because the rotationally driven intermediate transfer belt 5 is already in contact with the photosensitive drum 1.

S306: Toner supply operation control is performed as discussed below.

S307: The toner supply operation control is ended, toner is supplied as a lubricant to the photosensitive drum 1, and once this toner reaches the cleaning member 6, the frictional force of the cleaning member 6 is reduced. As a result, completion of the initial preparatory operation as an operation to reduce the initial frictional force of the cleaning member 6 is written into the memory of the process cartridge 7. Since the process cartridge 7 does not require initial preparatory operation once the data about completion of the initial preparatory operation have been received, the cartridge is then judged not to be new in step S302.

S308: Drum rotation drive is stopped.

S309: The system is now in a standby state in which image formation operation is possible (image formation Ready). However, if a print job is transmitted during the initial preparatory operation for example, an image forming operation may still be performed after the step S307, which completes the operation of reducing the initial frictional force.

In this example, a system of communicating with a memory tag installed in the process cartridge is adopted as the means of judging whether the process cartridge is new or not. However, the means of judging whether the process cartridge is new or not necessarily limited to the method of this example, and the effects of this example can also be obtained with another method.

Moreover, in this example an intermediate transfer belt system is adopted as the transfer member, but similar effects can also be obtained with a system of direct transfer from the photosensitive drum to paper or the like as long as contact with the photosensitive drum is possible during the initial preparatory operation.

The toner supply operation control is explained next. The object of the toner supply operation control is to supplying toner from the developing unit 4 to the photosensitive drum 1 and to give the toner a lubricant function by supplying it to the area of contact between the cleaning member 6 and the photosensitive drum 1 in conjunction with the rotational drive of the photosensitive drum 1.

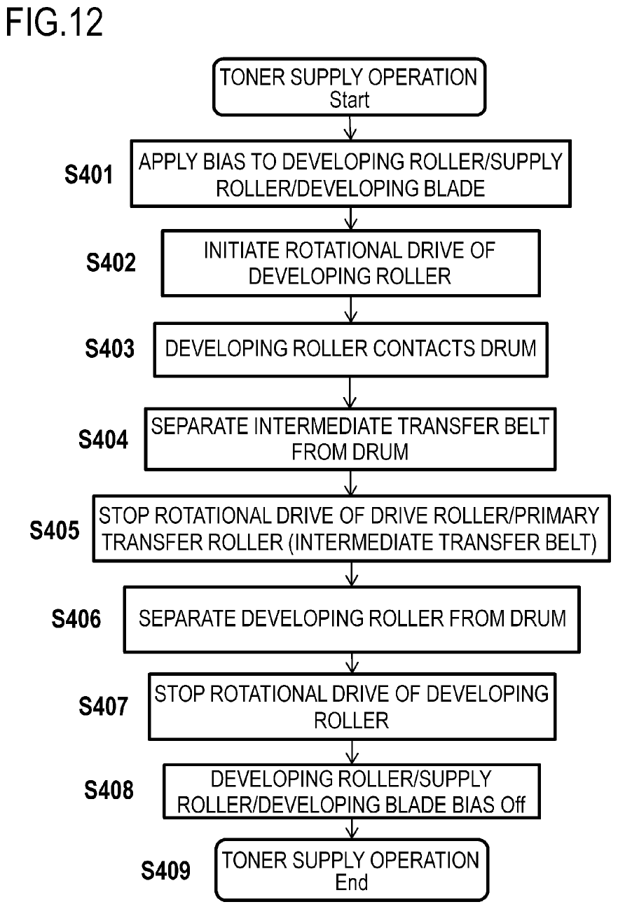

FIG. 12 shows the sequence of the toner supply operation control of this example, and the actual control is explained in detail here.

S401: Toner supply bias is applied by the developing bias source S4 to the supply roller 20 and the developing roller 17 of the developing unit 4, and by the blade bias source S6 to the developing blade 21. This toner supply bias may be any that allows the toner to be developed on the photosensitive drum 1, and in this example the bias applied to the developing blade 21 is −400 V, while the bias applied to the developing roller 17 and supply roller 20 is −300 V.

S402: The developing roller 17 of the developing unit 4 begins to be rotationally driven.

S403: The developing roller 17 contacts the photosensitive drum 1, initiating toner supply to the photosensitive drum 1.

S404: The toner suppled to the photosensitive drum 1 from the developing roller 17 is conveyed along with the rotation of the photosensitive drum 1, and the primary transfer roller 8 is separated before the toner reaches the area of contact with the intermediate transfer belt 5, thereby separating the intermediate transfer belt 5 from the photosensitive drum 1. In this example, the toner supplied to the photosensitive drum 1 is prevented from contacting the intermediate transfer belt 5 so that the toner can be supplied efficiently to the cleaning member 6 without contaminating the intermediate transfer belt 5. Moreover, in this example the developing roller 17 has a peripheral speed ratio of 130% relative to the photosensitive drum 1, and the load of the photosensitive drum 1 is reduced because the rotationally driven developing roller 17 is already in contact with the photosensitive drum in step S403.

S405: The drive of the intermediate transfer belt 5 is stopped by stopping the rotational drive of the drive roller 51 and primary transfer roller 8.

S406: Once the photosensitive drum 1 has progressed a predetermined distance after contacting the developing roller 17 in step S403, the developing roller 17 is separated from the photosensitive drum 1. The predetermined distance may be any distance at which sufficient toner can be supplied to reduce the frictional force between the cleaning member 6 and the photosensitive drum 1. In this example, this is a width of 15 mm.

S407: The rotational drive of the developing roller 17 is stopped.

S408: The toner supply bias applied to the developing roller 17, supply roller 20 and developing blade 21 is turned to OFF.

S409: The toner supply operation is completed, and the sequence returns to step S307 of the initial preparatory operation.

In this example, toner supply operation control is performed during the initial preparatory operation control when a new process cartridge is inserted However, other controls may also be performed in parallel with this control or interposed during this control as necessary.

Furthermore, a case in which one new process cartridge is inserted for the first time is explained in this example for reasons of simplicity, but similar control can also be applied to each cartridge in cases in which multiple process cartridges are inserted at the same time for example. This is also applicable to a monochrome image forming device that presupposes the insertion of only one process cartridge for example.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-238269, filed on Dec. 27, 2019, which is hereby incorporated by reference herein in its entirety.

What is claimed is:

1. An image forming apparatus comprising:
a cartridge provided with a rotatable image bear member;
a rotating member rotatable in contact with the surface of the image bearing member;
first drive unit for rotationally driving the image bearing member;
second drive unit for rotationally driving the rotating member;
detection unit for detecting the usage state of the cartridge; and
a control portion,
wherein prior to the image forming operation of forming an image, when the detection unit detects that the cartridge is an unused cartridge,
the control portion performs a preparatory operation of initiating rotational drive of the rotating member in a first rotational speed by the second drive unit, and then initiating rotational drive of the image bearing member by the first drive unit with the surface of the rotating member in contact with the surface of the image bearing member, and then, driving the rotating member in a second rotational speed smaller than the first rotational speed and
wherein a ratio of the surface movement speed of the first rotational speed of the rotating member to the surface movement speed of the image bearing member in the preparatory operation is greater than the ratio of the surface movement speed of the rotating member to the surface movement speed of the image bearing member in the image forming operation.

2. The image forming apparatus according to claim 1,
wherein the rotating member is constituted of an intermediate transfer belt.

3. The image forming apparatus according to claim 1,
wherein the image bearing member and the rotating member are configured such that the image bearing member and the rotating member are capable of taking a contact state in which the image bearing member contacts the rotating member and a separation state in which the image bearing member is separated from the rotating member.

4. The image forming apparatus according to claim 1,
wherein the image forming apparatus is provided with a developer carrying member for supporting a developer, and
wherein the surface of the image bearing member is in contact with the surface of the developer carrying member during the preparatory operation.

5. The image forming apparatus according to claim 1,
wherein the developer is a non-magnetic one-component developer.

6. The image forming apparatus according to claim 1,
wherein the ratio in the preparatory operation is greater than 1.

7. The image forming apparatus according to claim 1,
wherein the ratio in the preparatory operation is not more than 1.2.

8. The image forming apparatus according to claim 1,
wherein the detection unit comprises reading portion for reading cartridge use history data from a memory installed in the cartridge.

9. The image forming apparatus according to claim 1, also provided with a cleaning member in contact with the surface of the image bearing member.

10. The image forming apparatus according to claim 9, further comprising a developing apparatus that supplies developer to the surface of the image bearing member to develop an electrostatic image formed on the surface of the image bearing member into a developer image,
wherein the preparatory operation includes a supply operation in which the developing apparatus supplies developer to the surface of the image bearing member, and
wherein the supply operation is performed after rotational drive of the image bearing member by the first drive unit has been initiated in the preparatory operation.

11. The image forming apparatus according to claim 10,
wherein rotational drive at the above ratio in the preparatory operation continues until the developer supplied to the surface of the image bearing member by the supply operation reaches the contact position between the surface of the image bearing member and the cleaning member.

12. The image forming apparatus according to claim 10, further comprising: a transfer member for transferring a developer image from the developer carrying member to the intermediate transfer member as the rotating member, and
an application unit for applying transfer bias to the transfer member,
wherein, in the preparatory operation, bias with the opposite polarity to the transfer bias applied to the transfer member during image formation is applied to the transfer member by the application unit during a period where the developer supplied to the surface of the image bearing member by the supply operation passes through the contact position between the image bearing member and the intermediate transfer member.

13. The image forming apparatus according to claim 1, wherein, the second rotational speed of the rotating member in the preparatory operation is same as a rotational speed of the rotating member in the image forming operation.

14. The image forming apparatus according to claim 1, wherein, a rotational speed of the image bearing member is constant in the preparatory operation.

15. The image forming apparatus according to claim 1, wherein, a rotational speed of the image bearing member in the preparatory operation is same as a rotational speed of the image bearing member in the image forming operation.
